(19) United States
(12) Patent Application Publication
(10) Pub. No.: US 2024/0265388 A1
(43) Pub. Date: Aug. 8, 2024

(54) CONTROL METHOD, APPARATUS, AND RECORDING MEDIUM

(71) Applicant: Panasonic Intellectual Property Corporation of America, Torrance, CA (US)

(72) Inventors: Naohisa NISHIDA, Osaka (JP); Ayaka NAKASAKA, Osaka (JP); Kakuya YAMAMOTO, Hyogo (JP)

(21) Appl. No.: 18/377,408

(22) Filed: Oct. 6, 2023

Related U.S. Application Data
(63) Continuation of application No. PCT/JP2022/018292, filed on Apr. 20, 2022.
(60) Provisional application No. 63/178,137, filed on Apr. 22, 2021.

(51) Int. Cl. G06Q 20/38; G06Q 30/0207; H04L 9/00

(52) U.S. Cl. CPC G06Q 20/389; G06Q 30/0215; H04L 9/50

(57) ABSTRACT

A control method includes: selecting one or more first transaction data items to be stored in a block, from a plurality of transaction data items stored in a pool area in a memory; and determining a difficulty of mining to be executed at a time of storing the one or more first transaction data items in a first blockchain, based on values of one or more first data items included in the one or more first transaction data items selected.

### CROSS REFERENCE TO RELATED APPLICATIONS

This is a continuation application of PCT International Application No. PCT/JP2022/018292 filed on Apr. 20, 2022, designating the United States of America, which is based on and claims priority of U.S. Provisional Patent Application No. 63/178,137 filed on Apr. 22, 2021. The entire disclosures of the above-identified applications, including the specifications, drawings and claims are incorporated herein by reference in their entirety.

### FIELD

The present disclosure relates to a control method, an apparatus, and a recording medium.

### BACKGROUND

Known is a technique of transmitting a request to search for a correct nonce to a plurality of mining devices, and transmitting a block containing the correct nonce and a data item to a blockchain network upon obtaining the correct nonce from any of the mining devices.

### CITATION LIST

### Patent Literature

PTL 1: Japanese Unexamined Patent Application Publication No. 2020-197822

### SUMMARY

It is an objective of the present disclosure to provide a control method, for example, which allows preferential storage of a data item with a greater value in a block.

A control method according to an aspect of the present disclosure includes: selecting one or more first transaction data items to be stored in a block, from a plurality of transaction data items stored in a pool area in a memory; and determining a difficulty of mining to be executed at a time of storing the one or more first transaction data items in a first blockchain, based on values of one or more first data items included in the one or more first transaction data items selected.

Note that this general and specific aspect of the present disclosure may be implemented using a system, a device, an integrated circuit, a computer program, or a computer-readable recording medium such as a CD-ROM, or any combination of systems, devices, integrated circuits, computer programs, or recording media. The present disclosure allows preferential storage of a data item with a greater value in a block.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 shows an example configuration of a management system according to an embodiment.

FIG. 2 shows an example configuration of a node according to the embodiment,

FIG. 3 shows a first example of a table of value information.

FIG. 4 is a table showing a first example of the relationship between a data item included in one transaction data item and a tag associated with the data item.

FIG. 5 shows a second example of the table of value information.

FIG. 6 is a table showing a second example of the relationship between a data item included in one transaction data item and a tag associated with the data item.

FIG. 7 shows a third example of the table of value information.

FIG. 8 shows a fourth example of the table of value information.

FIG. 9 shows a fifth example of the table of value information.

FIG. 10 shows a sixth example of the table of value information.

FIG. 11 shows an example configuration of a server according to the embodiment.

FIG. 12 is a sequence diagram showing an example operation of storing a transaction data item in a transaction pool.

FIG. 13 is a sequence diagram showing an example consensus algorithm of the management system according to the embodiment.

FIG. 14 is a sequence diagram showing an example consensus algorithm of the management system according to Variation 1.

FIG. 15 is a flowchart showing an example consensus algorithm of a management system according to Variation 2.

FIG. 16 is a sequence diagram showing an example consensus algorithm of a management system according to Variation 4.

FIG. 17 is a flowchart showing an example consensus algorithm of a management system according to Variation 5.

### DESCRIPTION OF EMBODIMENT

### Basis of the Present (Underlying Knowledge Forming Disclosure)

The background art as in PTL 1 describes, in the mining at the time of storing a block containing transaction data items in a blockchain, searching for a nonce with a hash value smaller than a search threshold, and storing, in the blockchain, a block containing data items and the correct nonce obtained in the search. In this mining, the priority of storing the transaction data items in the block is determined in accordance with the receipt time of the transaction data items and the fees paid for the mining for the transaction data items. However, useful data items needs to be widely open to the public and stored not to be falsified, thereby widely available to various users. That is, there is a need to store the useful data items preferentially in the blockchain.

To meet the need, the present inventors have thought of a control method, for example, which allows preferential storage of a data item with a greater value in a block.

A control method according to an aspect of the present disclosure includes: selecting one or more first transaction data items to be stored in a block, from a plurality of transaction data items stored in a pool area in a memory; and determining a difficulty of mining to be executed at a time of storing the one or more first transaction data items in a first blockchain, based on values of one or more first data items included in the one or more first transaction data items selected.

The difficulty is determined according to the values of the first data items and the mining is conducted at the determined difficulty. For example, the difficulty of the mining is lower as the values of the first data items are higher. Accordingly, the miner tends to receive a mining reward for the first a data item with a greater value. The lowering of the difficulty of the mining leads to reduction in the amount of processing by the processor and reduction in the power consumption of the computer. This encourages the miner to store the first a data item with a greater value more preferentially in the block. As a result, the first a data item with a greater value can be preferentially stored in the block.

The control method may further include: obtaining value information indicating values of one or more data items included in the plurality of transaction data items. The one or more first transaction data items may be selected from the plurality of transaction data items, based on the value information.

This configuration allows, for example, preferential storage of the first a data item with a greater value in the block.

The value information may include a table in which a value and a type of each of the data items determined in advance for the data item are associated with each other. The values of the one or more data items may be determined with reference to the table.

This configuration allows, for example, preferential storage of a data item with a greater value determined with reference to the following table in the block. In the table, a value and the type of each of the data items determined in advance for the data item are associated with each other.

A value of a data item of a type not included in the table may be fixed and determined in advance.

This configuration allows unique determination of the value of data item of the type not included in the table.

In the table, a data item of a first type may be associated with a positive value. A data item of a second type may be associated with a negative value.

This configuration does not easily allow the storage of the data item of the second type in the block. Accordingly, the memory consumption can be reduced.

An integrated value obtained by integrating the values of the one or more first data items in the selecting may be at least zero.

This configuration allows the selection of one or more first transaction data items with the integrated value of at least zero.

In the table, each of the types of the data items may be associated with a negative value.

This configuration allows exclusion of unnecessary data items with less value from the block. Accordingly, the memory consumption can be reduced.

A second transaction data item including the table may be stored in a second blockchain different from the first blockchain. The second blockchain may be managed by a second node different from the first node. The values of the one or more data items may be determined by obtaining the table from the second node and referring to the table.

This configuration allows the separate management of the data items and the values of the data items in different blockchains.

A second transaction data item including the table may be stored in the first blockchain. The values of the one or more data items may be determined by obtaining the table from the first blockchain and referring to the table.

This configuration allows the management of the data items and the values of the data items in the same blockchain.

The values in the table may be fixed and determined in advance.

This configuration allows the setting of the values according to the table to be fixed.

The difficulty of the mining may be determined to be lower as an integrated value is greater, by calculation based on the integrated value and a reference difficulty set as a reference. The integrated value may be obtained by integrating the values of the one or more first data items. Mining at the reference difficulty may be executed for the second transaction data item including the table.

This configuration allows different mining for the second transaction data item and for the one or more first transaction data items.

The one or more first transaction data items and the second transaction data item may be stored in blocks different from each other.

This configuration allows the management of the one or more first transaction data items and the second transaction data item in different blocks.

The determining the difficulty may include: calculating an integrated value obtained by integrating the values of the one or more first data items; and determining a difficulty of the mining based on the integrated value calculated.

This configuration allows, for example, preferential storage of the one or more first data items with a greater integrated value in the block.

The difficulty of the mining may be determined to be lower as the integrated value is greater, by calculation based on the integrated value and a reference difficulty set as a reference.

This configuration allows preferential storage of the one or more first data items with a greater integrated value in the block. The lowering of the difficulty of the mining leads to reduction in the amount of processing by the processor and reduction in the power consumption of the computer.

The values indicated by the value information may be represented by numerical values. The one or more first transaction data items may be each, among the plurality of transaction data items, a transaction data item including a data item with a value represented by a numerical value greater than or equal to a predetermined value.

This configuration allows preferential selection of transaction a data item with a greater value from the plurality of transaction data items.

The control method may include: searching for a nonce whose hash value calculated is equal to or smaller than a threshold indicated by the difficulty of the mining determined; and storing the one or more first transaction data items in a block and storing the block in the first blockchain, when the nonce is successfully found.

The control method may further include: obtaining a reward according to the difficulty of the mining.

The one or more first transaction data items may include: a third transaction data item including a data item with a first value; and a fourth transaction data item including a data item with a second value lower than the first value. Mining at the reference difficulty may be executed for the fourth transaction data item.

This configuration allows different mining for the third transaction data item and for the fourth transaction data item.

The types of the data items may be indicated by tags added to the data items. The control method may further include: obtaining a tag of each of the one or more data items included in the plurality of transaction data items; and determining the value associated in the table with the type of the data indicated by the tag obtained, as the value of the one or more data item.

This configuration allows the determination of the difficulty of the mining based on the value associated with the tag.

An apparatus according to an aspect of the present disclosure includes: a selector that selects one or more first transaction data items to be stored in a block, from a plurality of transaction data items stored in a pool area in a memory; and a determiner that determines a difficulty of mining to be executed at a time of storing the one or more first transaction data items in a first blockchain, based on values of one or more first data items included in the one or more first transaction data items selected.

The difficulty is determined according to the values of the first data items and the mining is conducted at the determined difficulty. This allows, for example, preferential storage of the first a data item with a greater value in the block.

Note that this general and specific aspect of the present disclosure may be implemented using a system, a device, an integrated circuit, a computer program, or a computer-readable recording medium such as a CD-ROM, or any combination of systems, devices, integrated circuits, computer programs, or recording media.

Now, an embodiment will be described with reference to the drawings. The embodiment described below is a mere specific example of the present disclosure, Specifically, the numerical values, shapes, materials, elements, the arrangement and connection of the elements, steps, step orders etc. shown in the following embodiment are thus mere examples, and are not intended to limit the scope of the present disclosure. Among the elements in the following embodiment, those not recited in the independent claims which embody the broadest concept of the present disclosure will be described as elements not essential to achieve the objective of the present disclosure but form a more preferred embodiment.

### Embodiment

First, a system configuration according to the present disclosure will be described.

A management system according to the present disclosure includes a plurality of nodes, and manages a first blockchain on a first distributed ledger of each node. Now, a configuration or other characteristics of the management system according to this embodiment will be described with reference to the drawings.

### Management System

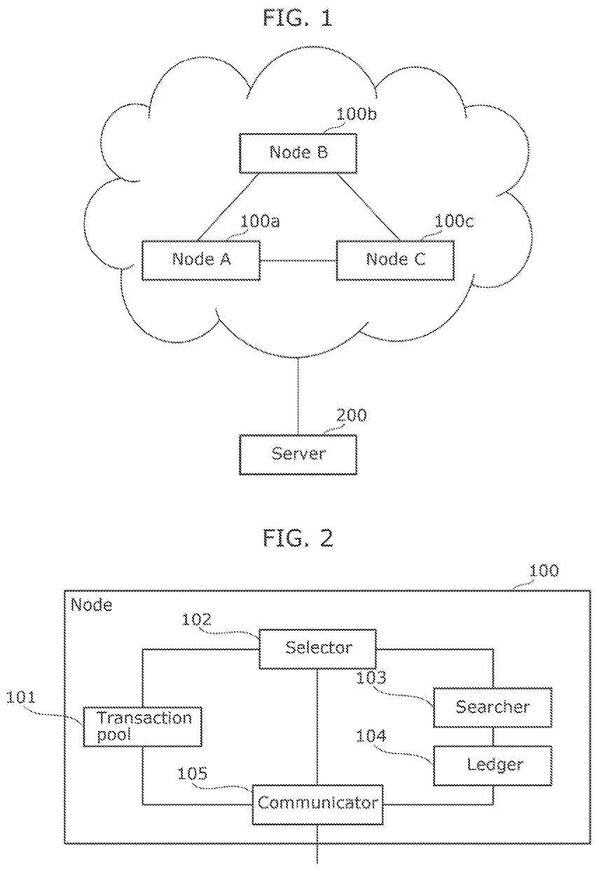

FIG. 1 shows an example configuration of the management system according to the embodiment.

As shown in FIG. 1, the management system according to this embodiment includes nodes 100a to 100c and server 200, for example. Nodes 100a to 100c and server 200 may be all connected by a network or directly and communicatively connected to each other. Some of nodes 100a to 100c and server 200 may be connected by a network and the others may be directly and communicatively connected to each other. The network is the Internet or a mobile carrier network, for example, but may be any communication line or network. Nodes 100a to 100c are examples of the plurality of devices forming the management system. The plurality of devices forming the management system are not necessarily nodes 100a to 100c but may also include one or more terminals or are only a plurality of terminals. Terminals are examples of an apparatus. The management system that manages a distributed ledger storing a blockchain may be any of public, private, and consortium types.

Note that each of nodes 100a to 100c may be hereinafter referred to as “node 100” and nodes 100a to 100c may be referred to as “nodes A to C”.

Now, each node 100 will be described.

### Node 100

Node 100 is an example of one of a plurality of terminals each including a distributed ledger.

Node 100 described here is one node 100 of nodes 100a to 100c. Among nodes 100a to 100c, the nodes other than this one node 100 will be referred to as “other nodes 100”. Other nodes 100 will be described in plural in this embodiment. Simply referred to as “other nodes 100” are a plurality of other nodes 100. Note that the number of other nodes 100 is not limited to the plural and may be one.

FIG. 2 shows an example configuration of each node according to the embodiment.

As shown in FIG. 2, node 100 includes transaction pool 101, selector 102, searcher 103, ledger 104, and communicator 105. Node 100 is achieved by a processor executing a predetermined program, using a memory. Now, the elements will be described.

### Transaction Pool 101

Transaction pool 101 is a pool area in a memory and temporarily stores a plurality of transaction data items. Transaction pool 101 temporarily stores, for example, transaction data items whose validity is verified.

### Selector 102

Selector 102 selects one or more first transaction data items to be stored in a block from the plurality of transaction data items stored in transaction pool 101. Selector 102 executes the selection described above at a time of generating the block. Specifically, selector 102 selects one or more first transaction data items to be stored in the block, based on the reward (fees) available by mining or a conceivable difficulty of mining. The reward is set for each transaction data item. Selector 102 may select one or more first transaction data items to obtain the maximum reward. Selector 102 may select one or more first transaction data items to conduct the mining at the least difficulty. Selector 102 selects one or more first transaction data items from the plurality of transaction data items, based on value information. The value information indicates the values of one or more data items included in the plurality of transaction data items stored in transaction pool 101. Note that the value information is obtained from server 200. The value information will be described later.

Whether selector 102 selects one or more first transaction data items to obtain the maximum reward or to conduct the mining at the least difficulty may be set in advance by a user.

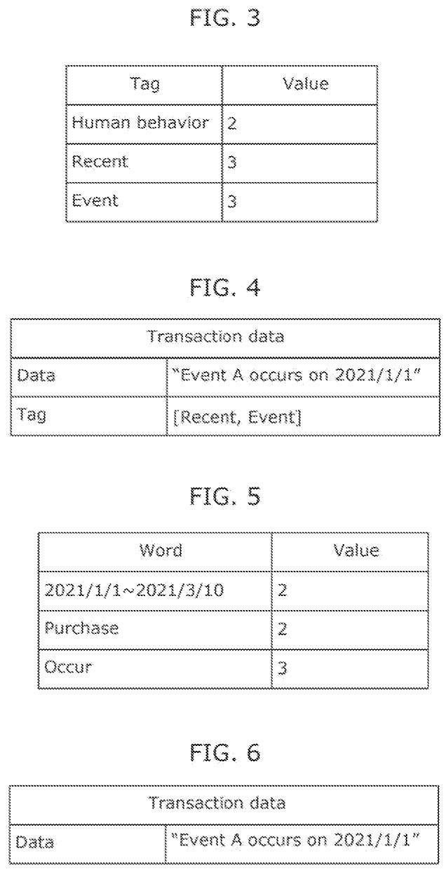

FIG. 3 shows a first example of the table of value information.

As shown in FIG. 3, the value information according to the first example is in the form of a table in which a value and the type of each of the data items represented by tags are associated with each other. The types of the data items are determined in advance for the respective data items, for example, as tags.

### Searcher 103

Searcher 103 determines the difficulty of the mining based on the integrated value of the selected one or more first transaction data items, and searches for the nonce according to the determined difficulty of mining. Searcher 103 sequentially applies a hash function for each of the plurality of specified nonces, thereby determining whether a hash value is available which is smaller than the threshold according to the difficulty of the mining. A smaller threshold is set for a higher difficulty of mining. Assume that the nonce with a hash value smaller than or equal to the threshold determined by the difficulty of the mining is successfully found. In this case, searcher 103 executes the processing of generating a block containing one or more first transaction data items and storing the block in the first blockchain.

In this manner, searcher 103 executes a consensus algorithm for the agreement on the validity of one or more first transaction data items, together with other nodes 100. A known consensus algorithm is used. Examples of the known consensus algorithm include proof of work (PoW), proof of stake (POS), or proof of importance (PoI). Upon verifying the validity of the one or more first transaction data items, searcher 103 causes ledger 104 to record the one or more first transaction data items. Upon failing to verify the validity of the one or more first transaction data items, searcher 103 causes ledger 104 not to record the one or more first transaction data items. Accordingly, the memory consumption can be reduced. This also allows omission of the processing of recording, in ledger 104, the transaction data items whose validity cannot be verified, which leads to reduction in the amount of processing by the processor. Accordingly, the power consumption of the computer can be reduced.

Now, specific processing of searcher 103 will be described.

Searcher 103 calculates the value of the one or more first data items included in the selected one or more first transaction data items. Searcher 103 specifies the value of each of the one or more first data items with reference to the table included in the value information. Searcher 103 obtains a tag of each of the one or more first data items, and calculates the value of the first transaction data items including the first data items, using the value associated with the tag obtained in the table.

If one first data item is associated with a plurality of tags, searcher 103 may calculate the sum of the values associated with the tags as the value of the one first data item. If one first data item is associated with a plurality of tags, searcher 103 may calculate the product of the values associated with the tags as the value of the one first data item.

FIG. 4 is a table showing a first example of the relationship between a data item included in one transaction data item and a tag associated with the data item.

One data item shown in FIG. 4 is associated with two tags, “Recent” and “Event”. In FIG. 3, the tag “Recent” is associated with the value “2”. The tag “Event” is associated with the value “3”. The values indicated by the value information are numerical values.

Accordingly, when calculating the sum of the plurality of values associated with the plurality of tags as the value of the one data item, searcher 103 obtains “5”, which is the sum of “2” and “3”, as the value of the one data item. On the other hand, when calculating the product of the plurality of values associated with the plurality of tags as the value of the one data item, searcher 103 obtains “6”, which is the product of “2” and “3”, as the value of the one data item.

In the example in FIG. 4, one transaction data item includes one data item. If being the sum of the tags, value of the one data item is “5”. Searcher 103 thus obtains the value “5” of the one data item as the value of one transaction data item.

Searcher 103 then calculates the integrated value obtained by integrating the values of one or more first data items. Specifically, searcher 103 may calculate the sum of the one or more values calculated in association with the one or more first data items, as the integrated value. Alternatively, searcher 103 may calculate the product of the one or more values calculated in association with the one or more first data items, as the integrated value. Note that the one or more first data items correspond to the one or more first transaction data items and the integrated value can be expressed as the whole value of the one or more first transaction data items.

Note that the value of each first transaction data item may be the sum of the values of the one or more tags associated with the first data items included in the first transaction data items. The integrated value may be the product of the one or more values calculated for the selected one or more first transaction data items. Alternatively, the value of each first transaction data item may be the product of the values of the one or more tags associated with the first data items included in the first transaction data items. The integrated value may be the sum of the one or more values calculated for the selected one or more first transaction data items.

Next, searcher 103 determines the difficulty of the mining to be executed at the time of storing one or more first transaction data items in a first blockchain, based on the calculated value of the one or more first data items. That is, searcher 103 determines the difficulty of the mining based on the integrated value. Specifically, searcher 103 determines the difficulty of the mining to be lower as the integrated value is greater, by calculation based on the integrated value and a reference difficulty set as a reference. Note that the threshold for searching for the nonce in the mining is lower as the difficulty is higher. Searcher 103 thus determines threshold A2 for searching for a nonce to be higher as integrated value V is higher, based on integrated value V and threshold A1 with respect to the reference difficulty. Searcher 103 may determine threshold A2, for example, as represented by Equation 1.

$$A 2 = A 1 * ( 100 + V ) / 100 \qquad ( 1 )$$

Note that searcher 103 not necessarily determines threshold A2, using Equation 1 but may determine threshold A2 to be higher as the integrated value is greater.

Now, other examples of the table of value information will be described.

FIG. 5 shows a second example of the table of value information. FIG. 6 is a table showing a second example of the relationship between a data item included in one transaction data item and a tag associated with the data item.

As shown in FIG. 5, the value information according to the second example is in the form of a table in which a values and the type of each of the data items represented by words are associated with each other.

One data item shown in FIG. 6 includes “Event A occurs on 2021/1/1” including the words “2021/1/1” and “occur”. In FIG. 5, the word “2021/1/1” is associated with the value “2” and the word “occur” is associated with the value “3”. Accordingly, when calculating the sum of a plurality of values associated with a plurality of tags as the value of the one data item, searcher 103 obtains “5”, which is the sum of “2” and “3”, as the value of the one data item.

On the other hand, when calculating the product of a plurality of values associated with a plurality of tags as the value of the one data item, searcher 103 obtains “6”, which is the product of “2” and “3”, as the value of the one data item.

In the example in FIG. 6, one transaction data item includes one data item. If being the sum of the tags, value of the one data item is “5”. Searcher 103 thus obtains the value “5” of the one data item as the value of the one transaction data item.

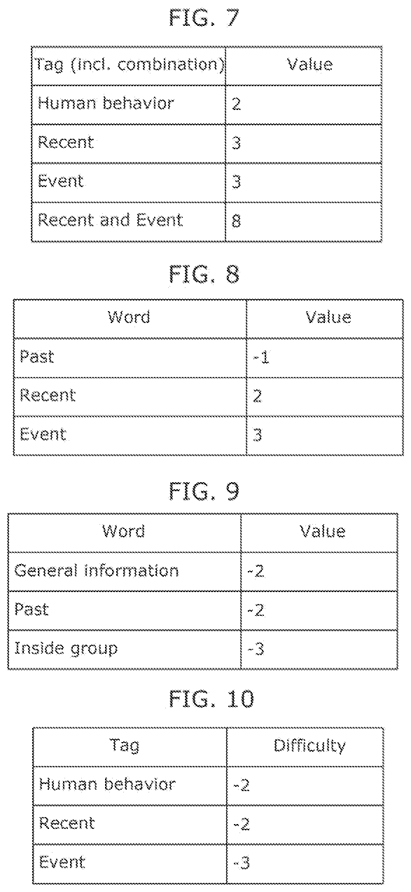

FIG. 7 shows a third example of the table of value information.

As shown in FIG. 7, the value information according to the third example is in the form of a table in which a values and the type of each of the data items represented by tags are associated with each other. The value information according to the third example differs from the value information according to the first example in including the relationship between a value and a combination of a plurality of tags. With the use of the value information according to the third example, searcher 103 may obtain the value “8” associated with the combination of the tags “Recent” and “Event”, as the value of the data item including the tags “Recent” and “Event”. Alternatively, searcher 103 may calculate the sum of the value “2” associated with the tag “Recent”, the value “3” associated with the tag “Event”, and the value “8” associated with the combination of the tags “Recent” and “Event”.

FIG. 8 shows a fourth example of the table of value information.

The value information according to the fourth example mainly differs from the value information according to the first to third examples in including positive and negative values. That is, according to the value information according to the fourth example, a data item of a first type is associated with a positive value, while a data item of a second type is associated with a negative value. As shown in FIG. 8, the value information according to the fourth example is in the form of a table in which a values and the type of each of the data items represented by words are associated with each other. The word “Past” is associated with the value “−1”. If a negative value is associated with a data type as in the fourth example, selector 102 may select one or more first transaction data items so that the integrated value is at least zero. Note that the integrated value is not limited thereto and may be less than zero. In the fourth example, searcher 103 may set a higher difficulty of the mining by setting the threshold for nonce search based on a negative value to be smaller than the threshold for nonce search based on a positive value. This does not easily allow the storage of data item of the second type, which is associated with a negative value, in a block. Accordingly, the memory consumption can be reduced.

FIG. 9 shows a fifth example of the table of value information.

The value information according to the fifth example differs from the value information according to the first to fourth examples including only negative values. That is, each data type may be associated with a negative value in the table. As shown in FIG. 9, the value information according to the fifth example is in the form of a table in which negative values and the types of the data items represented by tags are associated with each other. This reduces the values of the data items associated with the tags and does not easily allow the storage of one or more first transaction data items in a block. Accordingly, the memory consumption can be reduced.

FIG. 10 shows a sixth example of the table of value information.

The value information according to the sixth example indicates, instead of the values, drops in the difficulty of the mining in association with data types. As shown in FIG. 10, the value information according to the sixth example is in the form of a table in which the drops in the difficulty and the types of the data items represented by tags are associated with each other. In the case of the sixth example, searcher 103 may determine threshold A2, for example, as represented by Equation 2. When calculating the product as the data value in the value information according to the sixth example, searcher 103 may employ the product of absolute values or the absolute product.

$$A 2 = A 1 * ( 100 - V ) / 100 \qquad ( 2 )$$

### Ledger 104

Ledger 104 records transaction data items by storing a block including one or more first transaction data items whose validity is verified by searcher 103 in a first blockchain of a distributed ledger.

### Communicator 105

Communicator 105 transmits and receives one or more first transaction data items to and from other nodes 100 under a consensus algorithm. Note that communicator 105 may exchange data items other than the transaction with other nodes 100. Communicator 105 may also exchange data items with devices (i.e., terminals) other than other nodes 100. For example, communicator 105 may transmit a request for value information to server 200 and receive the value information from server 200.

In this manner, communicator 105 establishes communication with other nodes 100 or server 200. Note that this communication may be under the transport layer security (TLS) and communicator 105 may hold an encryption key for the TLS communication.

### Server 200

Server 200 is an example device holding a data value database including value information.

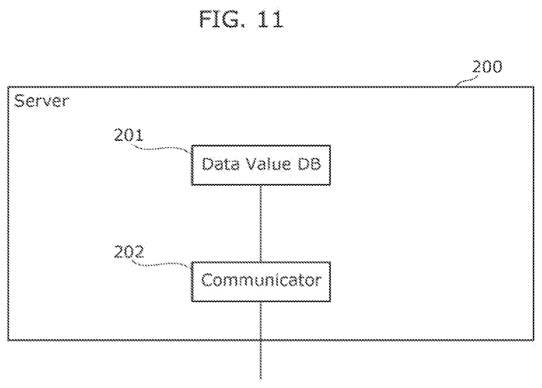

FIG. 11 shows an example configuration of the server according to the embodiment. Note that the data value database is expressed as “Data value DB” in FIG. 11.

As shown in FIG. 11, server 200 includes data value database 201 and communicator 202. Server 200 can be achieved by a processor executing a predetermined program using a memory. Now, the elements will be described.

### Data Value Database 201

Data value database 201 stores the tables of the value information described above.

### Communicator 202

Communicator 202 receives a request for value information from each node 100. Communicator 202 transmits the value information according to the request to node 100. Note that communicator 202 may exchange data items other than the request and value information with other nodes 100. Communicator 202 may also exchange data items with devices (i.e., terminals) other than nodes 100.

In this manner, communicator 202 establishes communication with other nodes 100. Note that this communication may be under the transport layer security (TLS) and communicator 202 may hold an encryption key for the TLS communication.

### Operation of Management System

Now, an operation of the management system with the configuration described above will be described.

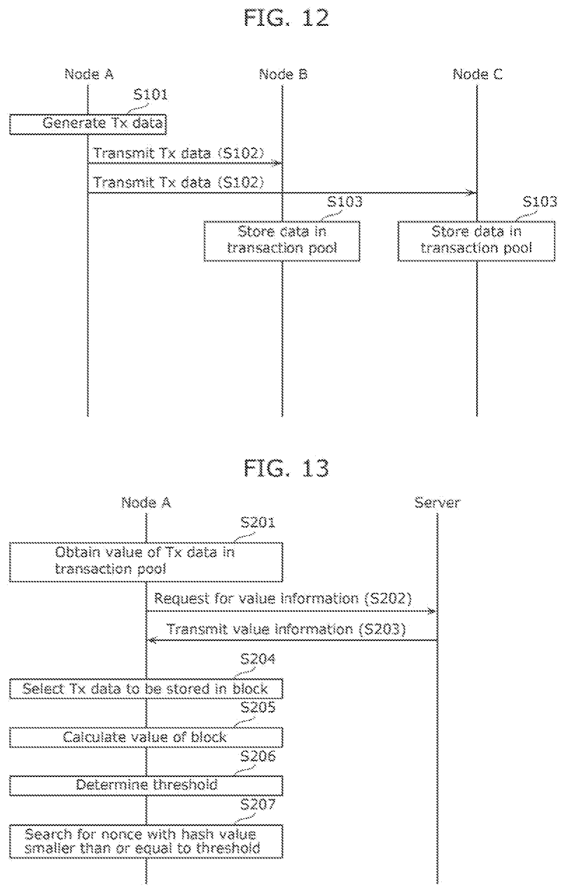

FIG. 12 is a sequence diagram showing an example operation of storing a transaction data item in a transaction pool.

Node A generates a transaction data item including a data item (S101). Note that the transaction data item is expressed as “Tx data” in FIG. 12.

Next, node A transmits the generated transaction data item to node B and node C (S102).

Upon receipt of the transaction data item from node A, node B and node C each store the received transaction data item in transaction pool 101 (S103). Note that node A may store the generated transaction data item in the transaction pool.

Note that not only node A but also node B or node C may generate a transaction data item including a data item and transmit the generated transaction data item to the other nodes. In this case, the other nodes each store the received transaction data item in transaction pool 101.

FIG. 13 is a sequence diagram showing an example consensus algorithm of the management system according to the embodiment. Node A starts the processing of obtaining the value of the data item included in the transaction data item in the transaction pool (S201).

Node A transmits a request for value information to server 200 (S202). In the request, the value information may be requested which is associated with the type of the data item whose value is to be specified. That is, in the request, there is no need to request the value information not associated with the type of the data item whose value is to be specified. The request may include information indicating the type of the data item whose value is to be specified. In the request, value information may be requested for each data item or for a plurality of data items as a whole.

Upon receipt of a request, server 200 transmits the value information according to the request to node A (S203). Server 200 transmits, to node A, the value information included in the request and corresponding to the information indicating the type of the data item. This leads to reduction in the amount of processing by the processor as compared to the case of transmitting all the holding value information to node A. Note that server 200 may transmit all its own value information to node A. As a result, node A obtains the value information according to the request.

Upon receipt of the value information, node A selects one or more first transaction data items to be stored in a block, from a plurality of transaction data items stored in transaction pool 101, based on the value information (S204).

Next, node A calculates the value of a block, that is, the whole value (i.e., the integrated value) of one or more first transaction data items to be stored in a block (S205).

After that, node A determines the threshold for nonce search as a difficulty of mining, based on the calculated integrated value (S206). Node A determines the threshold according to the type of the consensus algorithm. That is, node A determines a threshold for the POW when employing the POW as the consensus algorithm, a threshold for the POS when employing the POS as the consensus algorithm, and a threshold for the PoI when employing the PoI as the consensus algorithm.

Next, node A searches for a nonce with a hash value smaller than or equal to the determined threshold (S207).

### Advantageous Effects

As described above, node 100 of the management system according to the embodiment performs the control method for managing a first blockchain on a first distributed ledger. Node 100 selects one or more first transaction data items to be stored in a block, from a plurality of transaction data items stored in a pool area in a memory (S204). Node 100 then determines a difficulty of mining to be executed at a time of storing the one or more first transaction data items in the first blockchain, based on values of the one or more first data items included in the one or more first transaction data items selected (S206).

The difficulty is determined according to the values of the first data items and the mining is conducted at the determined difficulty. The difficulty of the mining is lower as the values of the first data items are higher and the miner tends to receive a mining reward for the first a data item with a greater value. This encourages the miner to store the first a data item with a greater value more preferentially in the block. As a result, the first a data item with a greater value can be preferentially stored in the block. The lowering of the difficulty of the mining leads to reduction in the amount of processing by the processor and reduction in the power consumption of the computer.

Node 100 obtains value information indicating the values of one or more data items included in the plurality of transaction data items (S203). The one or more first transaction data items are selected from the plurality of transaction data items, based on the value information.

This configuration allows, for example, preferential storage of the first a data item with a greater value in the block.

The value information includes a table in which a value and a type of each of the data items determined in advance for the data item are associated with each other. The values of the one or more data items are determined with reference to the table.

This configuration allows, for example, preferential storage of a data item with a greater value determined with reference to the following table in the block. In the table, the value and the type of each data item determined in advance for the data are associated with each other.

In the table, a data item of a first type is associated with a positive value, and a data item of a second type is associated with a negative value. The integrated value obtained by integrating the values of the one or more first data items in the selecting is at least zero.

This configuration does not easily allow the storage of the data item of the second type in the block. This configuration allows the selection of one or more first transaction data items with the integrated value of at least zero. Accordingly, the memory consumption can be reduced.

In the table, each of the types of the data items is associated with a negative value. This configuration allows exclusion of unnecessary data items with less value from the block. Accordingly, the memory consumption can be reduced.

In the determining the difficulty, node 100 calculates an integrated value obtained by integrating the values of the one or more first data items; and determining a difficulty of the mining based on the integrated value calculated.

This configuration allows, for example, preferential storage of the one or more first data item with a greater integrated value in the block.

The difficulty of the mining is determined to be lower as the integrated value is greater, by calculation based on the integrated value and a reference difficulty set as a reference.

This configuration allows preferential storage of the one or more first data item with a greater integrated value in the block.

### (Variation 1)

In the embodiment described above, server 200 stores value information, and node 100 obtains the value information from server 200. The configuration is however not limited thereto. The value information may be stored in a second blockchain different from the first blockchain.

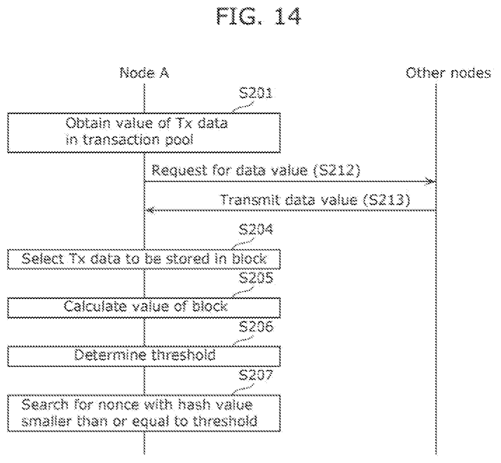

FIG. 14 is a sequence diagram showing an example consensus algorithm of a management system according to Variation 1.

Node A starts the processing of obtaining the value of the data item included in the transaction data item in the transaction pool (S201).

Node A transmits a request for value information to another node (S212). In the request, the value information may be requested which is associated with the type of the data item whose value is to be specified. That is, in the request, there is no need to request the value information not associated with the type of the data item whose value is to be specified. The request may include information indicating the type of the data item whose value is to be specified.

Upon receipt of a request, the other node transmits the value information according to the request to node A (S213). The other node transmits, to node A, the value information included in the request and corresponding to the information indicating the type of the data item. The other node may transmit all its own value information to node A. As a result, node A obtains the value information according to the request. The other node may be a plurality of nodes. The plurality of nodes may store, in a distributed ledger, a second blockchain which includes a block containing value information.

Upon receipt of the value information, node A selects one or more first transaction data items to be stored in a block, from a plurality of transaction data items stored in transaction pool 101, based on the value information (S204).

Next, node A calculates the value of a block, that is, the whole value (i.e., the integrated value) of one or more first transaction data items to be stored in a block (S205).

After that, node A determines the threshold for nonce search as a difficulty of mining, based on the calculated integrated value (S206). Node A determines the threshold according to the type of the consensus algorithm. That is, node A determines a threshold for the PoW when employing the POW as the consensus algorithm, a threshold for the PoS when employing the POS as the consensus algorithm, and a threshold for the PoI when employing the PoI as the consensus algorithm.

Next, node A searches for a nonce with a hash value smaller than or equal to the determined threshold (S207).

In this manner, in Variation 1, the second transaction data item including the table of value information is stored in the second blockchain different from the first blockchain. The second blockchain is managed by another node different from node A. The table of value information is obtained from the other node to determine the values of one or more data items with reference to the table of value information. This configuration allows the separate management of the data items and the values of the data items in different blockchains.

### (Variation 2)

In the embodiment and Variation 1 described above, server 200 or another node stores value information, and node 100 obtains the value information from server 200 or the other node. The configuration is however not limited thereto. The value information may be stored in the first blockchain managed by node 100.

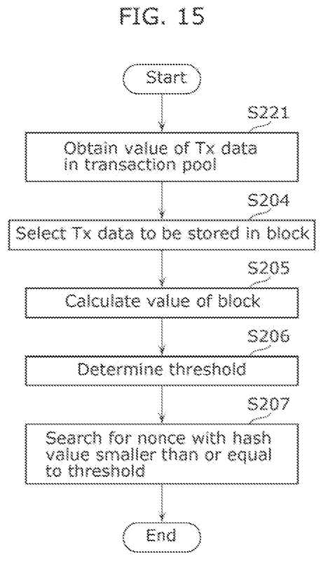

FIG. 15 is a flowchart showing an example consensus algorithm of a management system according to Variation 2.

Node A obtains the value of a data item included in a transaction data item in the transaction pool (S221). Specifically, node A obtains the value information stored in the first blockchain from the first blockchain stored in node A.

Upon receipt of the value information, node A selects one or more first transaction data items to be stored in a block, from a plurality of transaction data items stored in transaction pool 101, based on the value information (S204).

Next, node A calculates the value of a block, that is, the whole value (i.e., the integrated value) of one or more first transaction data items to be stored in a block (S205).

After that, node A determines the threshold for nonce search as a difficulty of mining, based on the calculated integrated value (S206). Node A determines the threshold according to the type of the consensus algorithm. That is, node A determines a threshold for the PoW when employing the POW as the consensus algorithm, a threshold for the POS when employing the POS as the consensus algorithm, and a threshold for the PoI when employing the PoI as the consensus algorithm.

Next, node A searches for a nonce with a hash value smaller than or equal to the determined threshold (S207).

In this manner, in Variation 2, the second transaction data item including a table of value information is stored in the first blockchain. Node A obtains a table of value information from the first blockchain to determine the values of one or more data items with reference to the table of value information. Accordingly, the data items and the values of the data items can be managed in the same blockchain.

Assume that a data item including a table of value information is stored in transaction pool 101 and stored in the first blockchain by node A. In this case, the value of the second transaction data item including the data item is fixed and determined in advance.

The mining with a reference difficulty may be executed on the second transaction data item. That is, the difficulty of the mining at the time of storing the first transaction data items in the first blockchain is different from the difficulty of the mining at the time of storing the second transaction data item in the first blockchain. This configuration allows different mining for the second transaction data item and for the one or more first transaction data items.

The one or more first transaction data items and the second transaction data item may be stored in different blocks. This configuration allows the management of the one or more first transaction data items and the second transaction data item in different blocks.

### (Variation 3)

In Variation 2 described above, server 200 or another node stores value information, and node 100 obtains the value information from server 200 or the other node. The configuration is however not limited thereto. The value information may be stored in a third blockchain managed by node 100. The third blockchain is different from the first blockchain.

In this manner, in Variation 3, the second transaction data item including a table of value information is stored in the third blockchain. Node A obtains the table of value information from the third blockchain to determine the values of one or more data items with reference to the table of value information.

### (Variation 4)

Node A may provide and receive a reward for mining in addition to the operation according to the embodiment described above.

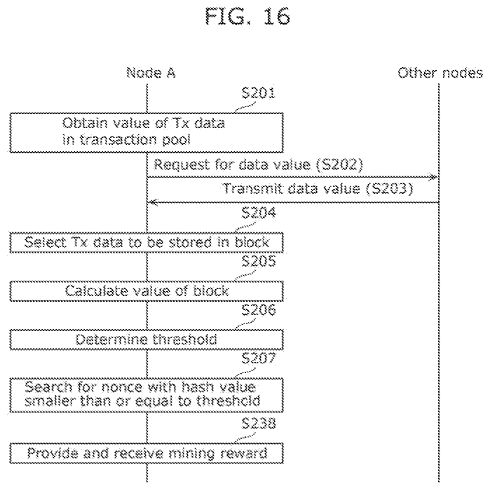

FIG. 16 is a sequence diagram showing an example consensus algorithm of a management system according to Variation 4.

Node A starts the processing of obtaining the value of a data item included in a transaction data item in the transaction pool (S201).

Node A transmits a request for value information to server 200 (S202). In the request, the value information may be requested which is associated with the type of the data item whose value is to be specified. That is, in the request, there is no need to request the value information not associated with the type of the data item whose value is to be specified. The request may include information indicating the type of the data item whose value is to be specified.

Upon receipt of a request, server 200 transmits value information according to the request to node A (S203). Server 200 transmits, to node A, the value information included in the request and corresponding to the information indicating the type of the data item. This leads to reduction in the amount of processing by the processor as compared to the case of transmitting all the holding value information to node A. Note that server 200 may transmit all its own value information to node A. As a result, node A obtains the value information according to the request.

Upon receipt of the value information, node A selects one or more first transaction data items to be stored in a block, from a plurality of transaction data items stored in transaction pool 101, based on the value information (S204).

Next, node A calculates the value of a block, that is, the whole value (i.e., the integrated value) of one or more first transaction data items to be stored in a block (S205).

After that, node A determines the threshold for nonce search as a difficulty of mining, based on the calculated integrated value (S206). Node A determines the threshold according to the type of the consensus algorithm. That is, node A determines a threshold for the PoW when employing the POW as the consensus algorithm, a threshold for the POS when employing the POS as the consensus algorithm, and a threshold for the PoI when employing the PoI as the consensus algorithm.

Next, node A searches for a nonce with a hash value smaller than or equal to the determined threshold (S207).

If successfully finding a nonce smaller than or equal to the threshold earlier than the other nodes, node A obtains the reward for mining (S238). The reward may be coins under a blockchain platform (e.g., Bitcoin or Ethereum) employed. For example, Bitcoin may employ, as the reward for mining, the sum of a certain amount of newly issued coins and fees determined for one or more first transaction data items contained in a block. The fees for the first transaction data items are in the form of coins requested to the user when the user generates the first transaction data items. The fees and the amount of coins are determined depending on the data size of the first transaction data items.

The reward for mining may be determined based on the values of the first data items included in the first transaction data items.

Depending on mining, coins may be further newly issued at an amount determined based on the values of the first data items. The reward may be determined by adding the further newly issued coins to the reward described above.

The management system may determine the sum of a fixed amount of reward and fees as the reward. The fixed amount may be changed in accordance with the values of the first data items.

### (Variation 5)

Node A may further provide and receive reward for mining in addition to the operation according to Variation 2 described above.

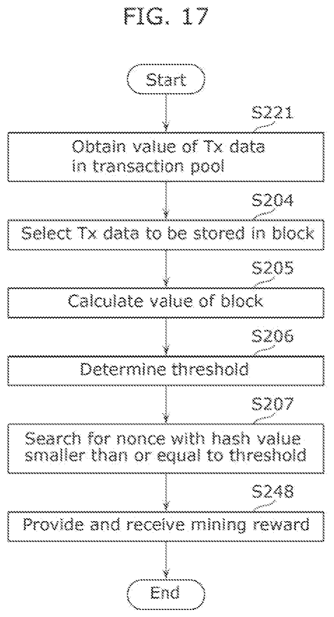

FIG. 17 is a flowchart showing an example consensus algorithm of a management system according to Variation 5.

Node A obtains the value of a data item included in a transaction data item in the transaction pool (S221). Specifically, node A obtains the value information stored in the first blockchain from the first blockchain stored in node A.

Upon receipt of the value information, node A selects one or more first transaction data items to be stored in a block, from a plurality of transaction data items stored in transaction pool 101, based on the value information (S204).

Next, node A calculates the value of a block, that is, the whole value (i.e., the integrated value) of one or more first transaction data items to be stored in a block (S205).

After that, node A determines the threshold for nonce search as a difficulty of mining, based on the calculated integrated value (S206). Node A determines the threshold according to the type of the consensus algorithm. That is, node A determines a threshold for the POW when employing the POW as the consensus algorithm, a threshold for the POS when employing the POS as the consensus algorithm, and a threshold for the PoI when employing the PoI as the consensus algorithm.

Next, node A searches for a nonce with a hash value smaller than or equal to the determined threshold (S207).

After that, node A obtains reward for mining (S248). The reward may be coins under a blockchain platform (e.g., Bitcoin or Ethereum) employed. For example, Bitcoin may employ, as the reward for mining, the sum of a certain amount of newly issued coins and fees determined for one or more first transaction data items contained in a block. The fees for the first transaction data items are in the form of coins requested to the user when the user generates the first transaction data items. The fees and the amount of coins are determined depending on the data size of the first transaction data items.

The reward for mining may be determined based on the values of the first data items included in the first transaction data items. Depending on mining, coins may be further newly issued at an amount determined based on the values of the first data items. The reward may be determined by adding the further newly issued coins to the reward described above. The difficulty of the mining is determined based on the values of the first data items. It can thus be said that the reward for mining determined based on the values of the first data items is determined in accordance with the difficulty of the mining.

The management system may determine the sum of a fixed amount of reward and fees as the reward. The fixed amount may be changed in accordance with the values of the first data items item.

### (Variation 6)

While not particularly described, in the embodiment and Variations 1 to 5 described above, selector 102 performs as follows when selecting one or more first transaction data items from a plurality of transaction data items in the transaction pool. Selector 102 may select one or more transaction data items including a data item with a value represented by a numerical value greater than or equal to a predetermined value from the plurality of transaction data items, as one or more first transaction data items. This allows preferential selection of transaction a data item with a greater value from the plurality of transaction data items.

Note that selector 102 may calculate the value of one transaction data item and determine a transaction data item to be determined as one or more first transaction data items, depending on whether the value of the transaction data item is greater than or equal to a predetermined value.

### (Others)

Searcher 103 may set, to a fixed value, the value of a data item of a type associated with none of the values according to the value information. That is, the value of a data item of a type not included in a table may be fixed and determined in advance. For example, if a data item belongs to none of the types of the data items associated with the values according to the value information, searcher 103 calculates the value of the data item as a fixed value. Note that the case where “a data item belongs to none of the types of the data items associated with the values according to the value information” corresponds to the following cases. In a case, the data item includes no tag associated with any value according to the value information. In another case, the data item includes no word associated with any value according to the value information. Accordingly, the value of data item of types not included in the table can be determined uniquely.

Assume that the one or more first transaction data items includes a third transaction data item including a data item with a first value, and a fourth transaction data item including a data item with a second value lower than the first value. In this case, node 100 may also execute mining at a difficulty determined based on the reference difficulty and the integrated value on the third transaction data item. Node 100 may execute mining at the reference difficulty on the fourth transaction data item. This configuration allows different mining for the third transaction data item and for the fourth transaction data item. For example, the data item with the second value may be value information.

### Other Embodiments

The present disclosure have been described above based on the embodiments. Needless to mention, the present disclosure is not limited to the embodiments described above. The present disclosure includes the following cases.
(1) Specifically, the devices in the embodiment described above are each a computer system including a microprocessor, a read-only memory (ROM), a random-access memory (RAM), a hard disk unit, a display unit, a keyboard, or a mouse. The RAM or the hard disk unit stores computer programs. The microprocessor operates in accordance with the computer programs so that the device fulfills its functions. Here, the computer programs are each obtained by combining a plurality of operation codes indicating commands to the computer to fulfill a predetermined function.
(2) Some or all of the elements of each device according to the embodiment may serve as a single system large-scale integrated (LSI) circuit. The system LSI circuit is a super multifunctional LSI circuit manufactured by integrating a plurality of elements on a single chip, and specifically is a computer system including a microprocessor, a ROM, and a RAM, for example. The RAM stores computer programs. The microprocessor operates in accordance with the computer programs so that the system LSI circuit fulfills its functions.

The parts of the elements forming each of the devices described above may individually serve as chips, or some or all of the parts may be included in a single chip.

While the system LSI circuit is named here, the integrated circuit may be referred to an IC, an LSI circuit, a super LSI circuit, or an ultra-LSI circuit depending on the degree of integration. The circuit integration is not limited to the LSI. The devices may be dedicated circuits or general-purpose processors. A field programmable gate array (FPGA) programmable after the manufacture of an LSI circuit or a reconfigurable processor capable of reconfiguring the connections and settings of circuit cells inside an LSI may be employed.

Appearing as an alternative circuit integration technology to the LSI, another technology that progresses or deprives from the semiconductor technology may be used for integration of functional blocks. Biotechnology is also applicable.
(3) Some or all of the elements forming each of the devices described above may be each an IC card or a single module attachable to the device. The IC card or the module is a computer system including a microprocessor, a ROM, or a RAM. The IC card or the module may include a super multifunctional LSI circuit. The microprocessor operates in accordance with computer programs so that the IC card or the module fulfills its functions. This IC card or this module may have a tamper resistance.
(4) The present disclosure may be directed to the method described above. The present disclosure may also be directed to a computer program implementing this method using a computer or may be a digital signal under the computer program.

The present disclosure may be directed to a recording medium, such as, a flexible disk, a hard disk, a CD-ROM, an MO, a DVD, a DVD-ROM, a DVD-RAM, a Blu-ray Disc (BD, trademark), or a semiconductor memory having recorded thereon a computer program or a digital signal readable by a computer. The present disclosure may be a digital signal recorded in the recording medium.

The present disclosure may be directed to transmission of the computer program or the digital signal via a telecommunication line, a wireless or wired communication line, or a network represented by the Internet, or data broadcast, for example.

The present disclosure may be directed to a computer system including a microprocessor and a memory. The memory may store the computer program, and the microprocessor may operate in accordance with the computer program.

The program or the digital signal may be recorded in the recording medium and transferred or may be transferred via the network, for example, and executed by another independent computer system.
(5) The embodiment and the variations described above may be combined.

### INDUSTRIAL APPLICABILITY

The present disclosure is applicable to a control method, a server, and a program, for example, to a control method, an apparatus, and a program that allow preferential storage of a data item with a greater value in a block.

1. A control method comprising:
selecting one or more first transaction data items to be stored in a block, from a plurality of transaction data items stored in a pool area in a memory; and
determining a difficulty of mining to be executed at a time of storing the one or more first transaction data items in a first blockchain, based on values of one or more first data items included in the one or more first transaction data items selected.

2. The control method according to claim 1, further comprising:
obtaining value information indicating values of one or more data items included in the plurality of transaction data items, wherein
the one or more first transaction data items are selected from the plurality of transaction data items, based on the value information.

3. The control method according to claim 2, wherein
the value information includes a table in which a value and a type of each of the data items determined in advance for the data item are associated with each other, and
the values of the one or more data items are determined with reference to the table.

4. The control method according to claim 3, wherein
a value of a data item of a type not included in the table is fixed and determined in advance.

5. The control method according to claim 3, wherein
in the table, a data item of a first type is associated with a positive value, and a data item of a second type is associated with a negative value.

6. The control method according to claim 5, wherein
an integrated value obtained by integrating the values of the one or more first data items in the selecting is at least zero.

7. The control method according to claim 3, wherein
in the table, each of the types of the data items is associated with a negative value.

8. The control method according to claim 3, wherein
a second transaction data item including the table is stored in a second blockchain different from the first blockchain,
the second blockchain is managed by a second node different from a first node, and
the values of the one or more data items are determined by obtaining the table from the second node and referring to the table.

9. The control method according to claim 3, wherein
a second transaction data item including the table is stored in the first blockchain, and
the values of the one or more data items are determined by obtaining the table from the first blockchain and referring to the table.

10. The control method according to claim 9, wherein
the values in the table are fixed and determined in advance.

11. The control method according to claim 9, wherein
the difficulty of the mining is determined to be lower as an integrated value is greater, by calculation based on the integrated value and a reference difficulty set as a reference, the integrated value being obtained by integrating the values of the one or more first data items, and
mining at the reference difficulty is executed for the second transaction data item including the table.

12. The control method according to claim 11, wherein
the one or more first transaction data items and the second transaction data item are stored in blocks different from each other.

13. The control method according to claim 2, wherein
the determining the difficulty includes:
calculating an integrated value obtained by integrating the values of the one or more first data items; and
determining a difficulty of the mining based on the integrated value calculated.

14. The control method according to claim 13, wherein
the difficulty of the mining is determined to be lower as the integrated value is greater, by calculation based on the integrated value and a reference difficulty set as a reference.

15. The control method according to claim 2, wherein
the values indicated by the value information are represented by numerical values, and
the one or more first transaction data items are each, among the plurality of transaction data items, a transaction data item including a data item with a value represented by a numerical value greater than or equal to a predetermined value.

16. The control method according to claim 2, further comprising:
searching for a nonce whose hash value calculated is equal to or smaller than a threshold indicated by the difficulty of the mining determined; and
storing the one or more first transaction data items in a block and storing the block in the first blockchain, when the nonce is successfully found.

17. The control method according to claim 2, further comprising:
obtaining a reward according to the difficulty of the mining.

18. The control method according to claim 14, wherein
the one or more first transaction data items includes:
a third transaction data item including a data item with a first value; and
a fourth transaction data item including a data item with a second value lower than the first value, and
mining at the reference difficulty is executed for the fourth transaction data item.

19. The control method according to claim 3, wherein
the types of the data items are indicated by tags added to the data items,
the control method further comprising:
obtaining a tag of each of the one or more data items included in the plurality of transaction data items; and
determining the value associated in the table with the type of the data indicated by the tag obtained, as the value of the one or more data item.

20. An apparatus comprising:
a selector that selects one or more first transaction data items to be stored in a block, from a plurality of transaction data items stored in a pool area in a memory; and
a determiner that determines a difficulty of mining to be executed at a time of storing the one or more first transaction data items in a first blockchain, based on values of one or more first data items included in the one or more first transaction data items selected.

21. A non-transitory computer-readable recording medium having recorded thereon a program for causing a computer to execute a control method, the program including:
selecting one or more first transaction data items to be stored in a block, from a plurality of transaction data items stored in a pool area in a memory; and
determining a difficulty of mining to be executed at a time of storing the one or more first transaction data items in a first blockchain, based on values of one or more first data items included in the one or more first transaction data items selected.
